(19) United States
(12) Patent Application Publication
(10) Pub. No.: US 2008/0307933 A1
(43) Pub. Date: Dec. 18, 2008

(54) Wrench rotatable in multiple orientations

(76) Inventor: Cheng-Ching Hung, Fenyuan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/812,268

(22) Filed: Jun. 18, 2007

(51) Int. Cl. B25B 23/16

(52) U.S. Cl. 81/177.8

(57) ABSTRACT

A wrench structure rotatable in multiple orientations includes a head portion, an extension element, and a holding portion. The rear end of the head portion has a first protruding connection part. The extension element includes a front end having a first concave connection part in connection with the first protruding connection part and a rear end having a second protruding connection part. The first concave connection part has a first side and a second side connected by a bottom edge. A stopping device is provided at an appropriate position on the bottom edge. The holding portion includes a front end having a second concave connection part in connection with the second protruding connection part and a rear end. The second concave connection part has a first side and a second side connected by a bottom edge. A stopping device is provided at an appropriate position on the bottom edge. It fixes the second protruding connection part as it rotates to a desired orientation. Such a structure allows the wrench to rotate in different orientations.

### BACKGROUND OF THE INVENTION

1. Field of Invention

The invention relates to a wrench structure rotatable in multiple orientations and, in particular, to a wrench structure with a two-section head portion that can be adjusted in multiple orientations.

2. Related Art

As shown in FIG. 5, the ratchet wrench 9 includes a holding portion 91. One end of the holding portion 91 is provided with a working head portion 91 1, which is connected with a connection rod 92. The other end of the connection rod 92 is mounted with a cylinder 93. The ratchet wrench is a hand tool commonly seen not only in factories but also at homes. The main feature of the ratchet wrench is in the combination of the ratchet wheel and the stopping element. When the user works with the wrench, he or she can swing the ratchet wrench back and forth without repeatedly mounting and dismounting the wrench on the ratchet wheel. This is why the ratchet wrench is superior to normal fixed wrenches.

Although the ratchet wrench has the above-mentioned advantage, it is not quite flexible in certain applications because of its simple structure. In particular, when the working space is limited and the working orientation has to change, the application of the ratchet wrench is very limited. It is therefore an objective of the invention to solve the above-mentioned problems.

### SUMMARY OF THE INVENTION

An objective of the invention is to provide a wrench structure rotatable in multiple orientations to have the functions of adjusting and positioning its head portion.

To achieve the above objective, the disclosed wrench structure rotatable in multiple orientations includes a head portion, an extension element, and a holding portion. The head portion has a rear end with a first protruding connection part that has several saws.

The extension element has a front end and a rear end. The front end has a first concave connection part corresponding to the first protruding connection part. The first concave connection part has a first side and a second side opposite to the first side. The two sides are connected by a bottom edge. An appropriate position on the bottom edge is provided with a first stopping device. The rear end has a second protruding connection part that has several saws.

The holding portion has a front end and a rear end. The front end has a second concave connection part corresponding to the second protruding connection part. The second concave connection part has a first side and a second side opposite to the first side. The two sides are connected by a bottom edge. A through hole formed on the bottom edge is provided with a second stopping device. The rear end is provided with a holder.

With the above combination, the wrench can rotate in different orientations.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the disclosed wrench;

FIG. 2 is a three-dimensional view of the disclosed wrench;

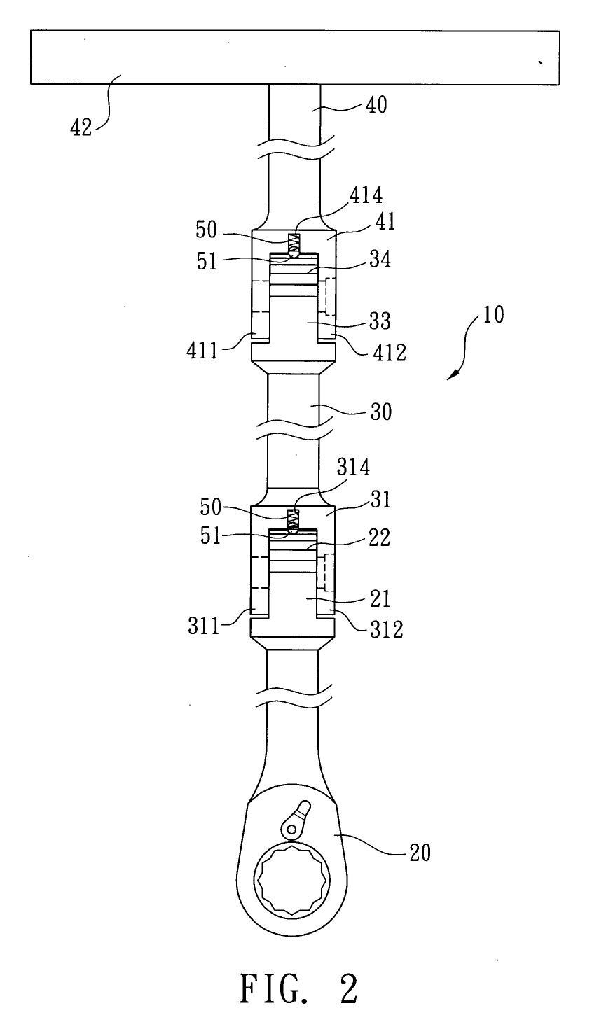

FIG. 3 is a locally enlarged schematic view of the invention where the head portion is fixed;

FIG. 4 is a three-dimensional view of another embodiment of the invention;

FIG. 5 is a schematic view of the invention with two sections of orientation changes; and

FIG. 6 is a three-dimensional exploded view of the conventional ratchet wrench.

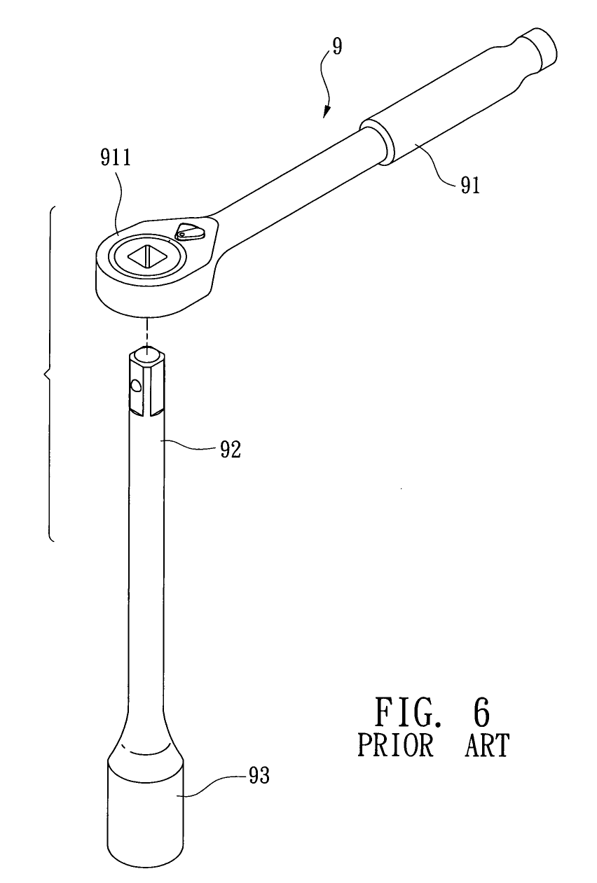

### DETAILED DESCRIPTION OF THE INVENTION

The present invention will be apparent from the following detailed description, which proceeds with reference to the accompanying drawings, wherein the same references relate to the same elements.

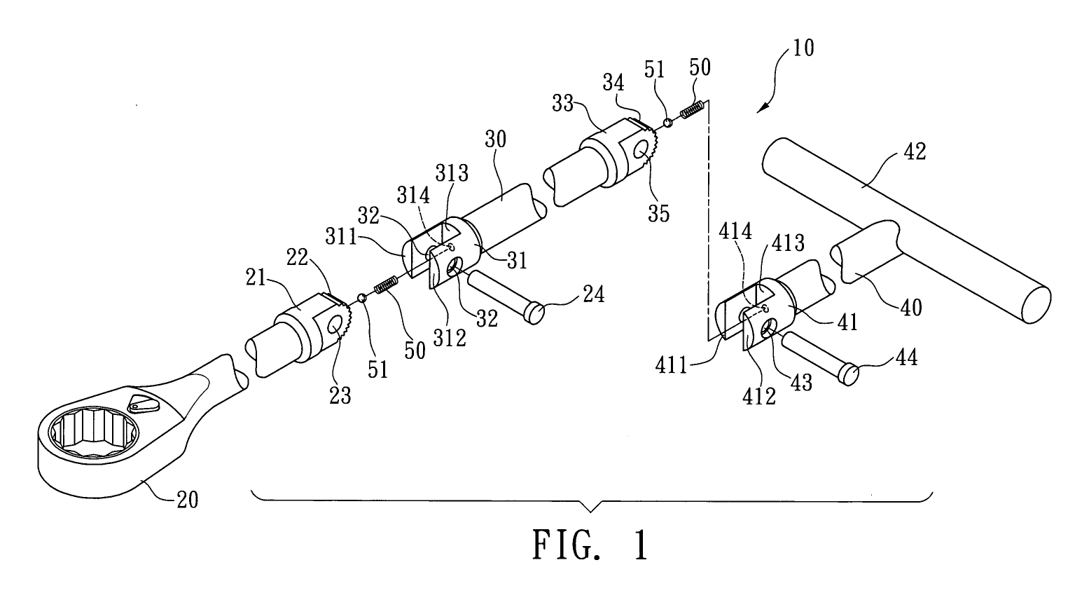

FIG. 1 is a three-dimensional exploded view of the disclosed wrench. The wrench 10 mainly includes a head portion 20, an extension element 30, and a holding portion 40. The head portion 20 has a rear end, and the rear end has a first protruding connection part 21. The first protruding connection part 21 has several saws 22. In this embodiment, the first protruding connection part 21 has a round surface and a through hole 23. The extension element 30 has a front end and a rear end. The front end has a first concaved connecting part 31. The first concaved connecting part 31 has a first side 311 and a second side 312 opposite to the first side 311. The two sides are connected by a bottom edge 313. A blind hole 32 with a stopping device is formed at an appropriate position on the bottom edge 313 corresponding to the saws 22 of the first protruding connection part 21. The stopping device includes a spring 50 and a steel ball 51 disposed at one end of the spring 50. The spring 50 is disposed inside the blind hole 32. The steel ball 51 is slightly exposed from one opening of the blind hole 32. A through hole 314 is formed on each of the first side 311 and the second side 312 corresponding to the through hole 23 for screw 24 or other fixing devices to penetrate horizontally through the first protruding connection part 21 and the first concave connecting part 31, rendering a free joint. The rear end of the extension element 30 has a second protruding connection part 33 with several saws 34. In this embodiment, the second protruding connection part 21 has a round surface and a through hole 35. The front end of the holding portion 40 has a second concave connection part 41. The second concave connection part 41 has a first side 411 and a second side 412 opposite to the first side 411. The two sides are connected by a bottom edge 413. A blind hole 414 is formed at an appropriate position on the bottom edge 413 corresponding to the saws 34 of the second protruding connection part 33. The blind hole 414 has a stopping device. The stopping device includes a spring 50 and a steel ball 51 disposed at one end of the spring 50. The spring 50 is disposed inside the blind hole 32. The steel ball 51 is slightly exposed from one opening of the blind hole 32. A through hole 43 is formed on each of the first side 411 and the second side 412 for screws 44 or other fixing devices to penetrate horizontally through the second protruding connection part 33 and the second concave connection part 41, rendering a free joint. The rear end of the holding portion 40 has a holder 42 for the user to hold.

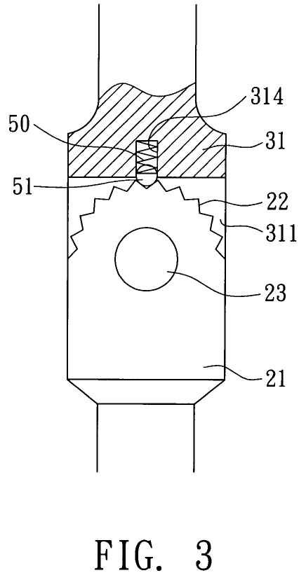

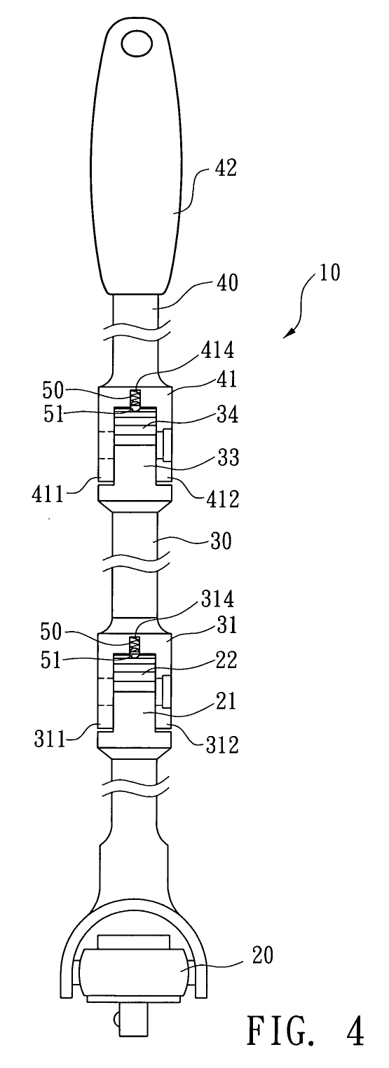

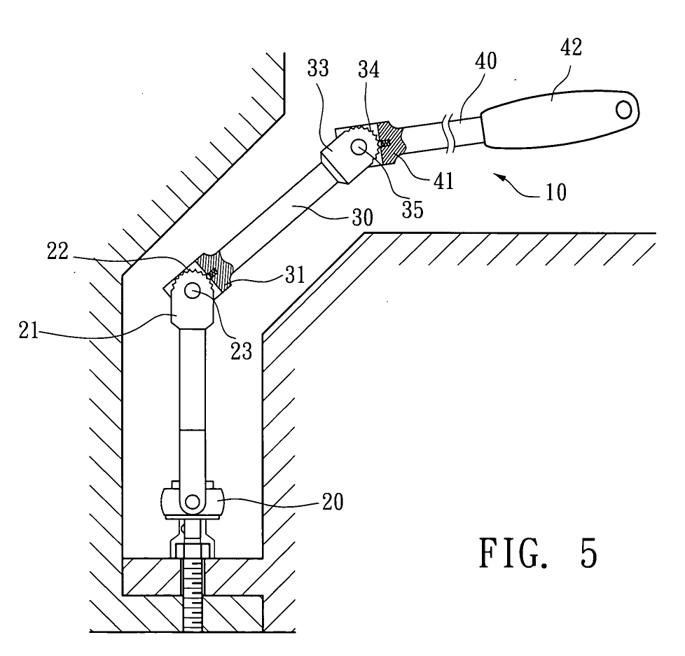

As described above, when the wrench 10 operates in the two-section multiple-orientation mode and the head portion is fixed by the stopping device, any saw tooth of the first protruding connection part 21 is positioned by the steel ball 51 (FIG. 3). The extension element 30 can be adjusted in different angles according to needs (FIG. 5). In another embodiment (FIG. 4), the holder 42 can be replaced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wrench structure rotatable in multiple orientations, comprising:
a head portion, which includes a rear end having a first protruding connection part with several saws;
an extension element, which has a front end having a first concave connection part in connection with the first protruding connection part and a rear end having a second protruding connection part with several saws;
wherein the concave connection part has a first side and a second side opposite to the first side, both sides are connected by a bottom edge, and a first stopping device is disposed at an appropriate position of the bottom edge; and
a holding portion, which has a front end having a second concave connection part in connection with the second protruding connection part and a rear end having a holder; wherein the second concave connection part has a first side and a second side opposite to the first side, both sides are connected by a bottom edge, and a second stopping device is disposed in a through hole formed on the bottom edge.

2. The wrench structure of claim 1, wherein the first protruding connection part and the second protruding connection part have round surfaces.

3. The wrench structure of claim 1, wherein each of the stopping devices includes a spring and a steel ball disposed at one end of the spring, the spring is disposed inside the through hole and the steel ball is partially exposed from one opening end of the through hole.
